(19) United States
(12) Patent Application Publication
(10) Pub. No.: US 2015/0242030 A1
(43) Pub. Date: Aug. 27, 2015

(54) TOUCH MODULE WITH PHOTOELECTRIC CONVERSION LAYER

(71) Applicant: Chih-Chung Lin, Taipei City (TW)

(72) Inventor: Chih-Chung Lin, Taipei City (TW)

(21) Appl. No.: 14/706,550

(22) Filed: May 7, 2015

Related U.S. Application Data
(62) Division of application No. 14/085,219, filed on Nov. 20, 2013.

(51) Int. Cl. G06F 3/047; G09G 5/00; G06F 3/041

(52) U.S. Cl. CPC G06F 3/047; G06F 3/0412; G09G 5/003; G09G 2300/0404

(57) ABSTRACT

A touch module with photoelectric conversion layer includes a transparent substrate, an anti-reflection layer, a shield layer, a first electrode layer, a first insulation layer, a second electrode layer, a second insulation layer, a wiring layer, a protection layer and a photoelectric conversion layer. The transparent substrate is defined with a touch section and a non-touch section. The photoelectric conversion layer is disposed in the touch section so that the total thickness of the touch module is reduced. Moreover, the photoelectric conversion layer is combined with the touch module to convert optical energy into electrical energy and provide the electrical energy for the touch module. Accordingly, the standby and use time of the touch module is prolonged.

### BACKGROUND OF THE INVENTION

1. Field of the Invention

The present invention relates generally to a touch module with photoelectric conversion layer including a photoelectric conversion layer. The photoelectric conversion layer is disposed in the touch section of the touch module so that the total thickness of the touch module is reduced. Moreover, the photoelectric conversion layer is combined with the touch module to convert optical energy into electrical energy and provide the electrical energy for the touch module. Accordingly, the use and standby time of the touch module is prolonged.

2. Description of the Related Art

It is important how to provide sufficient power for a portable electronic device for standby and use. Currently, the portable electronic device is still powered by an inbuilt battery. Some portable electronic devices are combined with touch modules. The power consumption of such portable electronic devices is even higher. As a result, the standby and use time of the portable electronic device is shortened.

In order to solve the problem of high power consumption of the conventional portable electronic device, a solar module is combined with the portable electronic device for converting solar energy into electrical energy and storing the electrical energy in the inbuilt battery of the portable electronic device so as to prolong the use and standby time of the portable electronic device. The solar module is mainly disposed in the non-touch section of the portable electronic device or the case of the portable electronic device. In this case, the case of the portable electronic device must be transparent for the solar module to absorb sunlight and convert the solar energy into electronic energy. Alternatively, the solar module must be positioned outside the case for absorbing the sunlight. As a result, the thickness of the portable electronic device can be hardly reduced.

### SUMMARY OF THE INVENTION

It is therefore a primary object of the present invention to provide a touch module with photoelectric conversion layer. The photoelectric conversion layer has larger light absorption area so that the magnitude of current produced by means of photoelectric conversion is increased. Accordingly, the use and standby time of the touch module is prolonged.

To achieve the above and other objects, the touch module with photoelectric conversion layer of the present invention includes a transparent substrate, an anti-reflection layer, a shield layer, a first electrode layer, a first insulation layer, a second electrode layer, a second insulation layer, a wiring layer, a protection layer and a photoelectric conversion layer. The transparent substrate has a first face and a second face. The transparent substrate is defined with a touch section and a non-touch section around the touch section. The anti-reflection layer is disposed on the first face of the transparent substrate. The shield layer is disposed on the non-touch section of the second face. The first electrode layer is disposed on the touch section of the second face of the transparent substrate to partially extend to the non-touch section. The first insulation layer is overlaid on one face of the first electrode layer. The second electrode layer is disposed on the other face of the first insulation layer, which face is distal from the first electrode layer. The second insulation layer is overlaid on the other face of the second electrode layer, which face is distal from the first insulation layer. The wiring layer has multiple wiring circuits. The wiring layer is disposed on the shield layer and some of the wiring circuits being electrically connected to the first electrode layer and some of the wiring circuits being electrically connected to the second electrode layer. The protection layer is overlaid on the second insulation layer and the wiring layer. The photoelectric conversion layer is disposed on the other face of the protection layer, which face is distal from the wiring layer.

Alternatively, the touch module with photoelectric conversion layer of the present invention includes a transparent substrate, an anti-reflection layer, a shield layer, a wiring layer, an electrode layer, an insulation layer, a lead layer, a protection layer and a photoelectric conversion layer. The transparent substrate has a first face and a second face. The transparent substrate is defined with a touch section and a non-touch section around the touch section. The anti-reflection layer is disposed on the first face of the transparent substrate. The shield layer is disposed on the non-touch section of the second face. The wiring layer has multiple wiring circuits, the wiring layer being correspondingly disposed on the shield layer. The electrode layer has a first electrode and a second electrode. The electrode layer is disposed on the touch section of the second face of the transparent substrate to partially extend to the non-touch section. The insulation layer is overlaid on the electrode layer and formed with multiple holes. The lead layer has multiple leads. The leads pass through the holes to selectively electrically connect to the first and second electrodes or the wiring layer. The protection layer is overlaid on the insulation layer and the lead layer. The photoelectric conversion layer is disposed on the other face of the protection layer, which face is distal from the lead layer.

Still alternatively, the touch module with photoelectric conversion layer of the present invention includes a transparent substrate, an anti-reflection layer, a shield layer, an electrode layer, multiple leads, a wiring layer, a protection layer and a photoelectric conversion layer. The transparent substrate has a first face and a second face. The transparent substrate is defined with a touch section and a non-touch section around the touch section. The anti-reflection layer is disposed on the first face of the transparent substrate. The shield layer is disposed on the non-touch section of the second face. The electrode layer has a first electrode and a second electrode. An insulation layer is disposed at a junction between the first and second electrodes. The leads are disposed on the insulation layer to selectively electrically connect to any of the first and second electrodes. The wiring layer has multiple wiring circuits. The wiring layer is disposed on one face of the shield layer. The wiring circuits are respectively electrically connected to the first and second electrodes. The protection layer is overlaid on the insulation layer, the leads and the wiring layer. The photoelectric conversion layer is disposed on the other face of the protection layer, which face is distal from the wiring layer.

The photoelectric conversion layer is combined with the touch module to convert optical energy into electrical energy and store the electrical energy in the touch module. Accordingly, the use and standby time of the touch module is prolonged. Moreover, the photoelectric conversion layer is disposed in the touch section of the touch module so that the total thickness of the touch module is reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the touch module with photoelectric conversion layer of the present invention;

FIG. 2 is a sectional assembled view of the first embodiment of the touch module with photoelectric conversion layer of the present invention;

FIG. 3 is a perspective exploded view of a second embodiment of the touch module with photoelectric conversion layer of the present invention;

FIG. 4 is a sectional assembled view of the second embodiment of the touch module with photoelectric conversion layer of the present invention;

FIG. 5 is a perspective exploded view of a third embodiment of the touch module with photoelectric conversion layer of the present invention; and

FIG. 6 is a sectional assembled view of the third embodiment of the touch module with photoelectric conversion layer of the present invention.

### DETAILED DESCRIPTION OF THE PREFERRED EMBODIMENTS

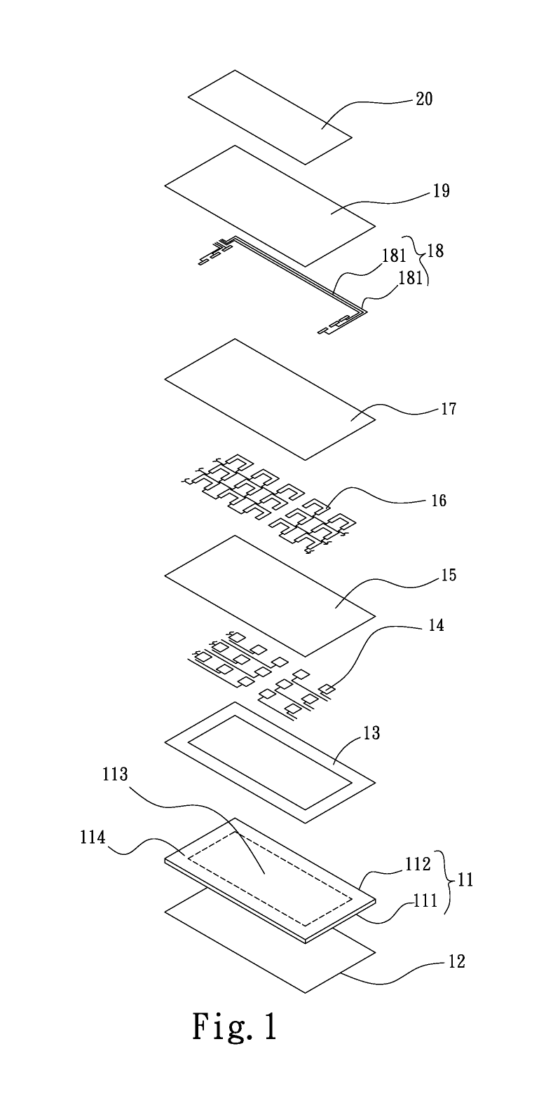

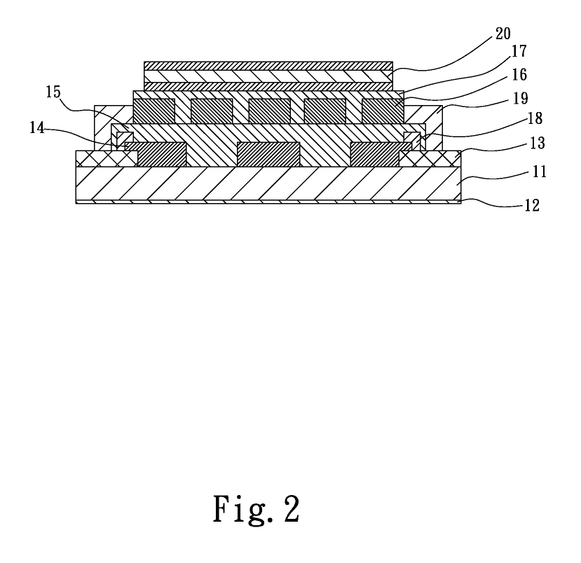

Please refer to FIGS. 1 and 2. FIG. 1 is a perspective exploded view of a first embodiment of the touch module with photoelectric conversion layer of the present invention. FIG. 2 is a sectional assembled view of the first embodiment of the touch module with photoelectric conversion layer of the present invention. According to the first embodiment, the touch module with photoelectric conversion layer of the present invention includes a transparent substrate 11, an anti-reflection layer 12, a shield layer 13, a first electrode layer 14, a first insulation layer 15, a second electrode layer 16, a second insulation layer 17, a wiring layer 18, a protection layer 19 and a photoelectric conversion layer 20.

The transparent substrate 11 has a first face 111 and a second face 112. The transparent substrate 11 is defined with a touch section 113 and a non-touch section 114 around the touch section 113. That is, the non-touch section 114 is disposed in adjacency to the periphery of the transparent substrate 11, while the touch section 113 is disposed at the center of the transparent substrate 11.

The anti-reflection layer 12 is disposed on the first face 111 of the transparent substrate 11. The shield layer 13 is disposed on the non-touch section 114 of the second face 112. The first electrode layer 14 is disposed on the touch section 113 of the second face 112 of the transparent substrate 11 to partially extend to the non-touch section 114. The first insulation layer 15 is overlaid on one face of the first electrode layer 14. The second electrode layer 16 is disposed on the other face of the first insulation layer 15, which face is distal from the first electrode layer 14.

The second insulation layer 17 is overlaid on the other face of the second electrode layer 16, which face is distal from the first insulation layer 15. The wiring layer 18 has multiple wiring circuits 181. The wiring layer 18 is disposed on the shield layer 13 and some of the wiring circuits 181 are electrically connected to the first electrode layer 14 and some of the wiring circuits 181 are electrically connected to the second electrode layer 16. The protection layer 19 is overlaid on the second insulation layer 16 and the wiring layer 18. The photoelectric conversion layer 20 is disposed on the other face of the protection layer 19, which face is distal from the wiring layer 18.

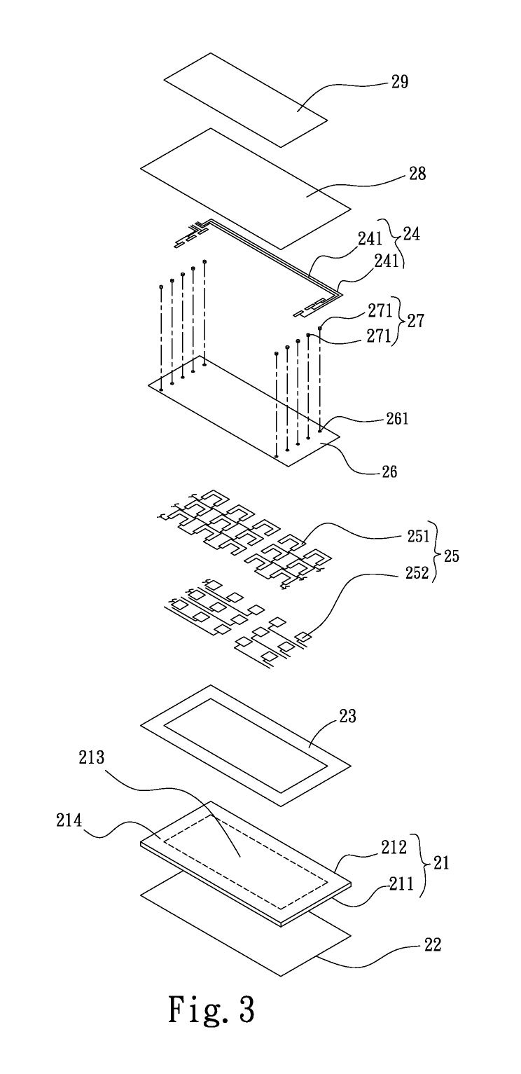

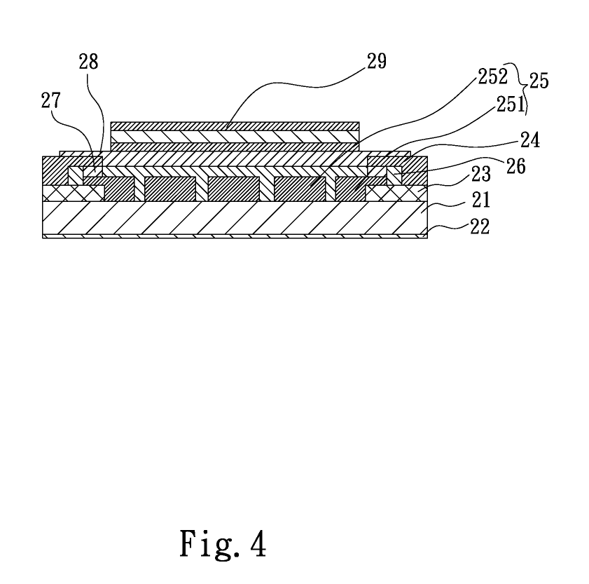

Please now refer to FIGS. 3 and 4. FIG. 3 is a perspective exploded view of a second embodiment of the touch module with photoelectric conversion layer of the present invention. FIG. 4 is a sectional assembled view of the second embodiment of the touch module with photoelectric conversion layer of the present invention. According to the second embodiment, the touch module with photoelectric conversion layer of the present invention includes a transparent substrate 21, an anti-reflection layer 22, a shield layer 23, a wiring layer 24, an electrode layer 25, an insulation layer 26, a lead layer 27, a protection layer 28 and a photoelectric conversion layer 29.

The transparent substrate 21 has a first face 211 and a second face 212. The transparent substrate 21 is defined with a touch section 213 and a non-touch section 214 around the touch section 213. The anti-reflection layer 22 is disposed on the first face 211 of the transparent substrate 21. The shield layer 23 is disposed on the non-touch section 214 of the second face 212. The wiring layer 24 has multiple wiring circuits 241. The wiring layer 24 is correspondingly disposed on the shield layer 23. The electrode layer 25 has a first electrode 251 and a second electrode 252. The electrode layer 25 is disposed on the touch section 213 of the second face 212 of the transparent substrate 21 to partially extend to the non-touch section 214.

The insulation layer 26 is overlaid on the electrode layer 25 and formed with multiple holes 261. The lead layer 27 has multiple leads 271. The lead layer 27 is disposed on the other face of the insulation layer 26, which face is distal from the electrode layer 25 and the wiring layer 24. The leads 271 pass through the holes 261 to selectively electrically connect to the first and second electrodes 251, 252 or the wiring layer 24. The protection layer 28 is overlaid on the insulation layer 26 and the lead layer 27. The photoelectric conversion layer 29 is disposed on the other face of the protection layer 28, which face is distal from the lead layer 27.

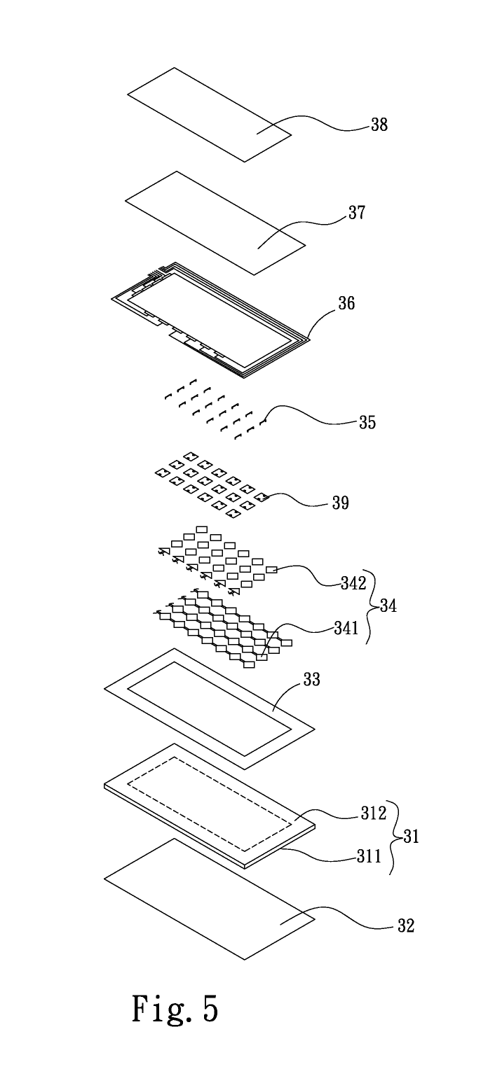

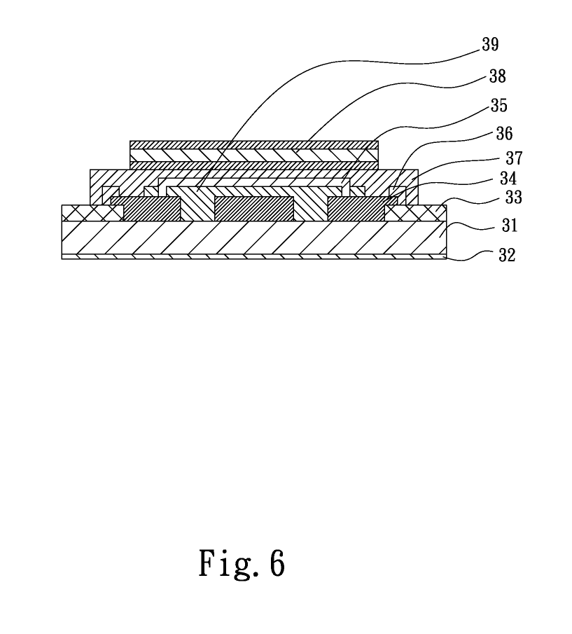

Please now refer to FIGS. 5 and 6. FIG. 5 is a perspective exploded view of a third embodiment of the touch module with photoelectric conversion layer of the present invention. FIG. 6 is a sectional assembled view of the third embodiment of the touch module with photoelectric conversion layer of the present invention. According to the third embodiment, the touch module with photoelectric conversion layer of the present invention includes a transparent substrate 31, an anti-reflection layer 32, a shield layer 33, an electrode layer 34, multiple leads 35, a wiring layer 36, a protection layer 37 and a photoelectric conversion layer 38.

The transparent substrate 31 has a first face 311 and a second face 312. The transparent substrate 31 is defined with a touch section 313 and a non-touch section 314 around the touch section 313. The anti-reflection layer 32 is disposed on the first face 311 of the transparent substrate 31. The shield layer 33 is disposed on the non-touch section 314 of the second face 312. The electrode layer 34 has a first electrode 341 and a second electrode 342. An insulation layer 39 is disposed at a junction between the first and second electrodes 341, 342. The leads 35 are disposed on the insulation layer 39 to selectively electrically connect to any of the first and second electrodes 341, 342. The wiring layer 36 has multiple wiring circuits 361. The wiring layer 36 is disposed on one face of the shield layer 33. The wiring circuits 361 are respectively electrically connected to the first and second electrodes 341, 342. The protection layer 37 is overlaid on the insulation layer 39, the leads 35 and the wiring layer 36. The photoelectric conversion layer 38 is disposed on the other face of the protection layer 37, which face is distal from the wiring layer 36.

In the first, second and third embodiments, the material of the transparent substrate is selected from a group consisting of glass, polymer and graphene. The polymer is selected from a group consisting of polyethylene terephthalate (PET), polycarbonate (PC), polyethylene (PE), polyvinyl chloride (PVC), polypropylene (PP), polystyrene (PS), polymethylmethacrylate (PMMA) and cyclo olefin copolymer (COC).

The photoelectric conversion layer is a thin-film solar battery. The first and second electrode layers and the electrode layer are coating structures formed by means of gelatinization, electroplating, evaporation or sputtering deposition. The coating structures are selected from a group consisting of indium tin oxide (ITO) coatings, indium zinc oxide (IZO) coatings and antimony tin oxide (ATO) coatings.

The photoelectric conversion layer is combined with the touch module to convert optical energy into electrical energy and store the electrical energy in the touch module. Accordingly, the use and standby time of the touch module is prolonged.

Moreover, the photoelectric conversion layer is disposed in the touch section of the touch module so that the total thickness of the touch module is reduced. Also, the case is no longer necessary to be transparent as in the conventional touch module.

The present invention has been described with the above embodiments thereof and it is understood that many changes and modifications in the above embodiments can be carried out without departing from the scope and the spirit of the invention that is intended to be limited only by the appended claims.

1-4. (canceled)

5. A touch module with photoelectric conversion layer, comprising:
a transparent substrate having a first face and a second face, the transparent substrate being defined with a touch section and a non-touch section around the touch section;
an anti-reflection layer disposed on the first face of the transparent substrate;
a shield layer disposed on the non-touch section of the second face;
a wiring layer having multiple wiring circuits, the wiring layer being correspondingly disposed on the shield layer;
an electrode layer having a first electrode and a second electrode, the electrode layer being disposed on the touch section of the second face of the transparent substrate to partially extend to the non-touch section;
an insulation layer overlaid on the electrode layer and formed with multiple holes;
a lead layer having multiple leads, the leads passing through the holes to selectively electrically connect to the first and second electrodes or the wiring layer;
a protection layer overlaid on the insulation layer and the lead layer; and
a photoelectric conversion layer disposed on the other face of the protection layer, which face is distal from the lead layer.

6. The touch module with photoelectric conversion layer as claimed in claim 5, wherein the material of the transparent substrate is selected from a group consisting of glass, polymer and grapheme.

7. The touch module with photoelectric conversion layer as claimed in claim 5, wherein the photoelectric conversion layer is a thin-film solar battery.

8. The touch module with photoelectric conversion layer as claimed in claim 6, wherein the polymer is selected from a group consisting of polyethylene terephthalate (PET), polycarbonate (PC), polyethylene (PE), polyvinyl chloride (PVC), polypropylene (PP), polystyrene (PS), polymethylmethacrylate (PMMA) and cyclo olefin copolymer (COC).

9-12. (canceled)
